(19) United States
(12) Patent Application Publication
(10) Pub. No.: US 2010/0269473 A1
(43) Pub. Date: Oct. 28, 2010

(54) CUT GRASS FLOW INDICATION IN A LAWN MOWER

(75) Inventors: Nicholas Hansen, Columbia, SC (US); Matthew Lambert, Summerville, SC (US); Kyle Michael Franke, Lexington, SC (US)

Correspondence Address: Pearne & Gordon LLP, 1801 East 9th Street, Suite 1200, Cleveland, OH, 44114-3108, US

(73) Assignee: Husqvarna Consumer Outdoor Products N.A., Inc., Augusta, GA (US)

(21) Appl. No.: 12/431,234

(22) Filed: Apr. 28, 2009

(51) Int. Cl. A01D 43/063; A01D 34/63; A01D 34/82; A01D 34/68

(52) U.S. Cl. 56/16.7; 56/202

(57) ABSTRACT

A mower 10 has a rearwardly directed discharge 24 and a handle 32 for gripping by an operator 12 walking behind the mower 10. A motor 18 powers a grass cutting operation to provide a flow of cut grass 26. A collection bag 36 has an inlet to mate with a discharge 24 of a cutting platform 16 for receiving flow of cut grass 26 there through. The bag 36 has a support 30 and a fabric enclosure 40. The fabric allows air to permeate there through while retaining cut grass 26. An opening 56 through the fabric is located on an upper side of the collection bag 36 and adjacent to the inlet of the collection bag 36. A transparent window 54 is attached to fabric and extends across the opening 56 through the fabric to permit the operator 12 to view the flow of cut grass 26 moving from the cutting platform 16 through the discharge 24 and into the bag 36 through the inlet of the collection bag 36 from an operator 12 position.

### FIELD OF THE INVENTION

The present invention relates generally to lawn mowers, and more particularly, to lawn mowers that have a rearwardly attached cut grass collection bag.

### BACKGROUND OF THE INVENTION

Walk-behind lawn mowers are well-known. Such a lawn mower may have a discharge opening from a mower deck that directs cut grass into a collection bag. With a collection bag mounted to the rear of the mower, there is often an internal frame within the bag. The collection bag generally maintains a shape and/or volume of the bag. A common problem associated with the use of a collection bag is an ability of an operator to accurately evaluate the filling ability of such a collection bag.

### BRIEF SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a walk-behind mower for cutting grass.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a side perspective view of a walk-behind mower (10) (10) (10) that includes an example of the present invention and also shows an operator located at an operator position;

FIG. 2 is a view of a portion of the mower of FIG. 1, with the view being generally from the operator location; and

FIG. 3 is a perspective view of just a collection bag of the mower of FIG. 1.

### DESCRIPTION OF EXAMPLE EMBODIMENTS

An example embodiment that incorporates one or more aspects of the present invention is described and illustrated in the drawings. This illustrated example is not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

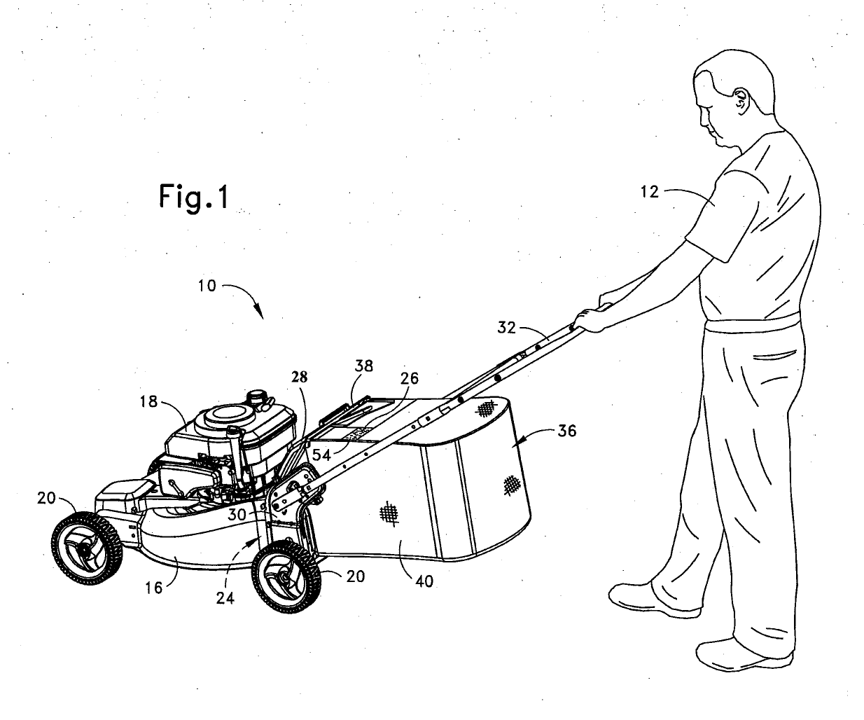

A walk-behind lawn mower 10 in accordance with one aspect of the present invention is shown in FIG. 1 along with an operator 12 located in an operator location. The lawn mower 10 includes a cutting platform 16 onto which a motor 18 is located. As can be appreciated, the motor 18 powers one or more cutting blades (not shown) that are located within the cutting platform 16 for cutting grass. In one example, the motor 18 drives the blade(s) to rotate. The blade(s) has sharpened portions. The rotating blade(s) are brought to bear against grass as the mower 10 is moved across a lawn. Thus, the motor 18 powers the grass cutting operation. The cutting platform 16 is generally supported by a plurality of ground engaging wheels 20 (only two visible). These wheels 20 may be freely rotatable or may be powered via a drive connection to the motor 18. The motor 18 may be of various constructions and configurations such as electric, fuel-powered, or other. Also, the one or more blades may have various constructions and configurations. Still further, the cutting platform 16 may have various configurations and features. In general, the cutting platform 16, motor 18, cutting blades may have known structures and features and may also have additional structures and features that are not shown herein.

One feature that the cutting platform 16 does have is a rearwardly directed discharge 24 for cut grass 26. The orientation of rearwardly is with respect to the normal direction that the walk-behind mower (10) 10 moves during the cutting operation. With reference to FIG. 1, a forward direction for the mower 10 would be to the left and the rearward direction would be to the right. It should be appreciated that the discharge 24 may have a variety of configurations, shapes, placements etc. on the rear side of the cutting platform 16.

In the shown example, a door 28 is movably mounted to the cutting platform 16. In the shown example, the door 28 is pivotable about an axis extending tranverse in the left-right direction that runs horizontally along a rearward and upper edge of the cutting platform 16. Thus, the door 28 is capable of pivoting in an arc about the rearward and upward edge of the cutting platform 16. Specifically, the door 28 is pivotable to a first door position (not shown) in which the door blocks the discharge 24 of the cutting platform 16. As can be appreciated, with the door 28 in the first door position, both ingress and egress through the discharge 24 of the cutting platform 16 is prevented. This door position is useful for a mulching function. The door 28 is pivotable upwardly and forwardly away from the first door position, which is the position shown in FIG. 1.

Also located at the rear side of the cutting platform 16 is at least one handle support 30 that is connected to the cutting platform. In the presented example, there are two supports 30 being located respectively on the left and right sides of the cutting platform 16. The supports 30 may have any of various constructions and configurations. In the shown example, each support 30 is a generally plate-like structure which may have one or more reinforcement segments provided via bending or contouring of the material. Each support 30 is shaped very generally as the letter “L,” but with the letter turned on one side. In general, the material is typically metal. However, different materials such as plastic composite may be utilized. A plurality of mounting holes, apertures, studs, weld points or the like are located on each support. These holes, etc. on a lower portion of the respective support 30 provide means to connect each support to the cutting platform 16.

An upper portion of each support 30 extends generally upwardly and rearwardly away from the cutting platform 16. Attached to the upper portion of each support 30 is an operator handle 32. In presented example, the operator handle 32 extends upwardly in a general U-shape from the cutting platform 16. The U-shape may be bifurcated to permit folding of the handle for storage. An upper portion of the handle 32 is at a generally ergonomic location to be held or gripped by the operator 12 who is located in an operator location directly behind the mower 10 and who is operating the mower. One or more operation components may be mounted upon the handle 32 for operation by the operator 12 to control the mower 10. Examples of such components include throttle, speed control, and the like. Accordingly, the operator handle 32 may have any of several configurations and constructions.

Turning back to the cutting platform 16 and the rearwardly directed discharge 24 therein, a bag mount (not shown) is located on the cutting platform adjacent to the discharge 24. The bag mount is for attaching a collection bag 36 onto the rearward side of the cutting platform 16 when the door is in the upper position. It is to be appreciated that the bag mount may have any of several constructions and configurations, including a receiving means for receiving pins located on the collection bag, and the like. Also, it is to be appreciated that the collection bag 36 may have any of several constructions and configurations. In general, the collection bag receives the cut grass 26 as the cut grass passes from the discharge 24. Accordingly, the collection bag 36 has an inlet that mates with the discharge 24 of the cutting platform 16 when the collection bag is located on the bag mount of the cutting platform.

The collection bag 36 has a support 38 that acts a frame. The support 38 may be made of various materials such as metal and/or plastic. The collection bag 36 has a fabric enclosure 40 supported by the support 38 bounding a bag interior into which cut grass 26 flows. In the disclosed example, most of the support 38 is located within the fabric enclosure 40 so that the fabric enclosure extends around the support. However, some portions of the support 38 are located outside of the fabric enclosure and/or penetrate through the fabric enclosure so that the support engages portions of the cutting platform 16 and/or the supports 30 on the deck. Thus, the bag 36 is held in place on the mower 10.

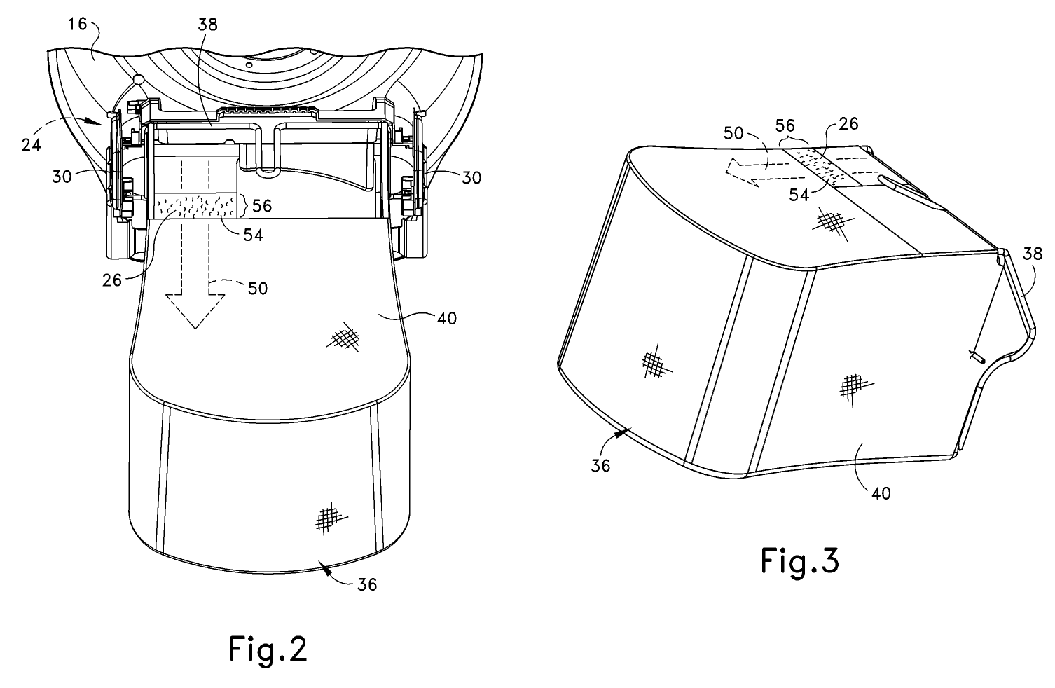

Turning to the cutting action performed by the mower 10, it is to be appreciated that the blade, and possibly other structure of the mower, provide and air force/flow. The cut grass 26 is moved by the air force/flow from the area bounded by the cutting platform 16 and through the discharge 24. Further the air force/flow moves through the inlet of the bag and into the interior or bounded area of the bag 36. This movement is shown by the dashed arrowhead 50 in FIG. 2. The fabric of the fabric enclosure 40 allows air to permeate there through while retaining cut grass 26. Thus, only the cut grass 26, and not air, is accumulated within the bag 36. In the shown example, the fabric is opaque.

At some point in time, it will become desirable to remove the collection bag 36 from the rear of the cutting platform 16. Typically, this occurs when a sufficient amount of cut grass 26 has accumulated within the collection bag 36. However, it is useful for the operator to accurately know when the sufficient amount of grass has accumulated. Or another way to approach this issue is whether the mower 10 is currently delivering cut grass 26 into the bag 36. Thus, in accordance with one aspect of the present invention, a transparent window 54 is provided on the bag to allow viewing into the interior of the bag. Specifically, the fabric has an opening 56 there through. The opening 56 can be created by cutting, stamping, or the like. The window 54 is attached to fabric of the enclosure 40 and extends across the opening 56 through the fabric to permit the operator to view the flow of cut grass 26 moving from the cutting platform through the discharge and into the bag through the inlet of the collection bag from the operator position.

The window 54 may be made of any suitable transparent material, such as flexible plastic. The window 54 may be attached to the fabric of the bag 36 in any suitable manner. For example, the window 54 may be sewn to the adjacent portion of the fabric of the bag 36. As another alternative, the window 54 may be glued to the adjacent fabric. Still further a grommet-type or flange-type connector may be used to fix the window 54 in the bag 36. It is contemplated that the window 54 may be fixed to the bag by any means or device.

It is to be recalled that the collection bag 36 has the inlet to mate with the rear discharge 24 of the cutting platform 16 for flow of cut grass 26 there through. The window 54 in the bag 36 is positioned on the bag and with reference to the outlet and the inlet such that the operator 12 can view the flow of cut grass 26 (i.e., see the dashed arrow head 50 shown in FIG. 2) moving from the cutting platform 16 through the discharge 24 and into the bag 36 through the inlet of the collection bag from the operator position. Thus, in the shown example, the window 54 is located on an upper side of the collection bag 36 and adjacent to the inlet of the bag. Specifically, in the shown example the window 54 is located at a forward left side of the top of the bag 36 because the discharge 24 from the mower deck is generally locate to the left side of the mower 10. Thus, the transparent window is located on a forward portion of the collection bag. The operator 12 has better ability to determine a sufficiently full condition of the bag 36 since the operator 12 is not merely seeing presence/accumulation of cut grass 26 but the flow (i.e., arrowhead 50) of cut grass 26.

Of course, many other specific applications, configurations, and constructions are contemplated. It is to be understood that all of the specific applications are intended to be within the scope of the subject invention.

From the above description of the invention, those skilled in the art will perceive improvements, changes and modifications. Such improvements, changes and modifications within the skill of the art are intended to be covered by the appended claims.

1. A walk-behind mower (10) for cutting grass including:
a cutting platform (16) within which grass is cut and having a rearwardly directed discharge (24) for cut grass (26);
a handle (32) connected to the cutting platform (16) for gripping by an operator (12) walking behind the mower (10) in an operator (12) position for operating the mower (10);
a motor (18) located on the cutting platform (16) for powering the grass cutting operation and flow of cut grass (26);
a collection bag (36) for receiving and retaining cut grass (26), the collection bag (36) having an inlet to mate with the discharge (24) of the cutting platform (16) for flow of cut grass (26) there through, the collection bag (36) having a support (30), a fabric enclosure (40) supported by the support (30) and bounding a bag (36) interior into which cut grass (26) flows, the fabric allowing air to permeate there through while retaining cut grass (26), an opening (56) through the fabric being located on an upper side of the collection bag (36) and adjacent to the inlet of the collection bag (36), and a transparent window (54) attached to fabric and extending across the opening (56) through the fabric to permit the operator (12) to view the flow of cut grass (26) moving from the cutting platform (16) through the discharge (24) and into the bag (36) through the inlet of the collection bag (36) from the operator position.

2. A walk-behind mower (10) as set forth in claim 1, wherein the transparent window (54) is located on an upper side of the collection bag (36).

3. A walk-behind mower (10) as set forth in claim 2, wherein the transparent window (54) is located on a forward portion of the collection bag (36).

4. A walk-behind mower (10) as set forth in claim 1, wherein the fabric of the collection bag (36) is opaque.
